(19) United States
(12) Patent Application Publication
(10) Pub. No.: US 2018/0288725 A1
(43) Pub. Date: Oct. 4, 2018

(54) METHOD AND SYSTEM FOR CONSTRUCTING A DATABASE OF WI-FI BEACON LOCATIONS

(71) Applicant: AthenTek Incorporated, Taipei City (TW)

(72) Inventors: Yi-Lin Chen, New Taipei City (TW); Yu-Hsiang Chang, New Taipei City (TW)

(21) Appl. No.: 15/472,188

(22) Filed: Mar. 28, 2017

(51) Int. Cl. H04W 64/00; G06F 17/30

(52) U.S. Cl. CPC H04W 64/00; H04W 84/12; G06F 17/30946

(57) ABSTRACT

A method for constructing a database of Wi-Fi beacon locations is provided. The method includes: storing raw observation data for Wi-Fi beacons in the database of Wi-Fi beacon locations; (b) generating observation data records for the Wi-Fi beacons according to the raw observation data, and computing a rough location estimate for each Wi-Fi beacon according to the observation data records; (c) finding outliers of each Wi-Fi beacon from the rough location estimate and the observation data records; (d) excluding the outliers from the observation data records, and computing final location estimates for the Wi-Fi beacons according to the observation data records which do not include the outliers; (e) computing inferred-location estimates for the Wi-Fi beacons which do not have a location fix according to the final location estimates; and (f) storing the inferred-location estimates in the beacon location database.

### BACKGROUND OF THE INVENTION

### Field of the Disclosure

The present disclosure relates generally to the field of database systems. More specifically, the present disclosure relates to a method and a system for constructing a database of Wi-Fi beacon locations.

### Description of the Related Art

Mobile devices can execute software to periodically report observation data including unique identifiers and signal strengths of visible beacons. However, if accurate positions of the visible beacons are not known, it may not be possible to determine the position of the mobile devices. Therefore, it is very important to have an accurate database of beacon locations.

In addition, some problems may be encountered when constructing a database of beacon locations. For example, some observation data may include erroneous locations (e.g. location outliers), a beacon reported in the observation data may be mobile, or some observation data do not have corresponding location estimates.

Therefore, a method and a system for constructing a database of Wi-Fi beacon locations are needed to solve the problems described above.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and a system for constructing a database of Wi-Fi beacon locations are provided.

In a preferred embodiment, a method for constructing a database of Wi-Fi beacon locations is provided in the disclosure. The method comprises: storing raw observation data for Wi-Fi beacons in the database of Wi-Fi beacon locations; (b) generating observation data records for the Wi-Fi beacons according to the raw observation data, and computing a rough location estimate for each Wi-Fi beacon according to the observation data records; (c) finding outliers of each Wi-Fi beacon from the rough location estimate and the observation data records; (d) excluding the outliers from the observation data records, and computing final location estimates for the Wi-Fi beacons according to the observation data records which do not include the outliers; (e) computing inferred-location estimates for the Wi-Fi beacons which do not have a location fix according to the final location estimates; and (f) storing the inferred-location estimates in the beacon location database.

In some embodiments, the observation data records include raw location estimates for the Wi-Fi beacons, and each raw location estimate has a location fix. In some embodiments, after computing the final location estimates for the Wi-Fi beacons, the method further comprises: determining whether a ratio of a number of outliers to a number of raw location estimates for a first Wi-Fi beacon is greater than a first threshold; adding a tag to the first Wi-Fi beacon when determining that the ratio of the first Wi-Fi beacon is greater than the first threshold; and storing the first Wi-Fi beacon with the tag in a second database comprised in the database of Wi-Fi beacon locations. In some embodiments, the rough location estimate for each Wi-Fi beacon is computed according to signal strength measured in the raw location estimates. In some embodiments, finding the outliers of each Wi-Fi beacon from the rough location estimate and the observation data records comprises: assigning a first raw location estimate for a first Wi-Fi beacon whose distance from the rough location estimate for the first Wi-Fi beacon exceeds a second threshold as the outlier. In some embodiments, computing the final location estimates further comprises: examining whether a mobile flag of a first Wi-Fi beacon is set to indicate that the first Wi-Fi beacon is a mobile beacon; computing the final location estimate for the first Wi-Fi beacon according to signal strengths measured in the raw location estimates for the first Wi-Fi beacon which does not include the outliers when examining the mobile flag of the first Wi-Fi beacon is not set to indicate that the first Wi-Fi beacon is a mobile beacon; and storing the final location estimate for the first Wi-Fi beacon in a second database, wherein the second database is comprised in the database of Wi-Fi beacon locations. In some embodiments, storing the final location estimate for the first Wi-Fi beacon in the second database further comprises: determining whether the final location estimate for the first Wi-Fi beacon conforms to rules utilized in the second database; and performing at least one action in response to a determination result, wherein the rules comprise: examining whether an original location estimate for the first Wi-Fi beacon has been stored in the second database; examining whether the mobile flag of the first Wi-Fi beacon is set to indicate that the first Wi-Fi beacon is a mobile beacon; examining whether the original location estimate for the first Wi-Fi beacon is measured by a user; examining whether a distance between the original location estimate and the final location estimate is greater than a third threshold. In some embodiments, the inferred-location estimates are stored in a first database comprised in the database of Wi-Fi beacon locations. In some embodiments, the first database is a non-relational database. In some embodiments, the second database is a relational database system (RDS).

In a preferred embodiment, a system for constructing a database of Wi-Fi beacon locations is provided in the disclosure. The system comprises a database of Wi-Fi beacon locations and a server, wherein the server is coupled to the database of Wi-Fi beacon locations. The server comprises a control circuit, a processor and a memory. The processor is installed in the control circuit. The memory is installed in the control circuit and is operatively coupled to the processor. The processor is configured to execute a program code stored in the memory to perform operations comprising: (a) storing raw observation data for Wi-Fi beacons in the database of Wi-Fi beacon locations; (b) generating observation data records for the Wi-Fi beacons according to the raw observation data, and computing a rough location estimate for each Wi-Fi beacon according to the observation data records; (c) finding outliers of each Wi-Fi beacon from the rough location estimate and the observation data records; (d) excluding the outliers from the observation data records, and computing final location estimates for the Wi-Fi beacons according to the observation data records which do not include the outliers; (e) computing inferred-location estimates for the Wi-Fi beacons which do not have a location fix according to the final location estimates; and (f) storing the inferred-location estimates in the beacon location database.

In some embodiments, the observation data records include raw location estimates for the Wi-Fi beacons, and each raw location estimate has a location fix. In some embodiments, after computing the final location estimates for the Wi-Fi beacons, the processor further executes the program code stored in the memory to perform operations comprising: determining whether a ratio of a number of outliers to a number of raw location estimates for a first Wi-Fi beacon is greater than a first threshold; adding a tag to the first Wi-Fi beacon when determining that the ratio of the first Wi-Fi beacon is greater than the first threshold; and storing the first Wi-Fi beacon with the tag in a second database comprised in the database of Wi-Fi beacon locations. In some embodiments, the rough location estimate for each Wi-Fi beacon is computed according to signal strength measured in the raw location estimates. In some embodiments, finding the outliers of each Wi-Fi beacon from the rough location estimate and the observation data records comprises: assigning a first raw location estimate for a first Wi-Fi beacon whose distance from the rough location estimate for the first Wi-Fi beacon exceeds a second threshold as the outlier. In some embodiments, computing the final location estimates further comprises: examining whether a mobile flag of a first Wi-Fi beacon is set to indicate that the first Wi-Fi beacon is a mobile beacon; computing the final location estimate for the first Wi-Fi beacon according to signal strength measured in the raw location estimates for the first Wi-Fi beacon which does not include the outliers when examining the mobile flag of the first Wi-Fi beacon is not set to indicate that the first Wi-Fi beacon is a mobile beacon; and storing the final location estimate for the first Wi-Fi beacon in a second database, wherein the second database is comprised in the database of Wi-Fi beacon locations. In some embodiments, storing the final location estimate for the first Wi-Fi beacon in the second database further comprises: determining whether the final location estimate for the first Wi-Fi beacon conforms to rules utilized in the second database; and performing at least one action in response to a determination result, wherein the rules comprise: examining whether an original location estimate for the first Wi-Fi beacon has been stored in the second database; examining whether the mobile flag of the first Wi-Fi beacon is set to indicate that the first Wi-Fi beacon is a mobile beacon; examining whether the original location estimate for the first Wi-Fi beacon is measured by a user; and examining whether a distance between the original location estimate and the final location estimate is greater than a third threshold. In some embodiments, the inferred-location estimates are stored in a first database comprised in the database of Wi-Fi beacon location. In some embodiments, the first database is a non-relational database. In some embodiments, the second database is a relational database system (RDS).

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1 is a schematic diagram illustrating the architecture of a communications system in accordance with one embodiment of the disclosure.

FIG. 2 shows an alternative simplified functional block diagram of a wireless communications device according to one embodiment of the present disclosure.

FIG. 3 is a simplified block diagram of the program code shown in FIG. 2 in accordance with one embodiment of the disclosure.

FIG. 4 illustrates a procedure for performing a method for constructing a database of Wi-Fi beacon locations between a first database, a second database and a server according to an embodiment of the present disclosure.

FIG. 5 is a table illustrating actions that the server may perform according to the rules according to one embodiment of the present disclosure.

FIG. 6 is a flow diagram illustrating a method for constructing a database of Wi-Fi beacon locations according to an embodiment of the present disclosure.

### DETAILED DESCRIPTION OF THE INVENTION

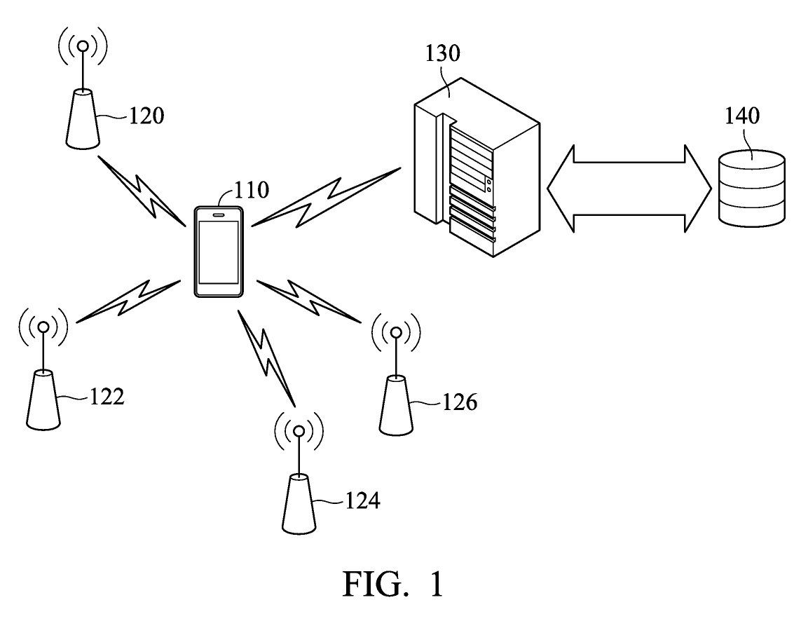

Several exemplary embodiments of the present disclosure are described with reference to FIGS. 1 through 6 which generally relate to a method and a system for constructing a database of Wi-Fi beacon locations. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

Discussions herein utilizing terms such as, for example, “storing”, “computing”, “generating”, “determining”, “finding”, “excluding”, “assigning”, “examining”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items. Further, like numerals refer to like elements throughout the several views, and the articles “a” and “the” includes plural references, unless otherwise specified in the description.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

In this disclosure, “Wi-Fi beacon”, “WLAN access point”, “AP”, “wireless access point” and similar terms all have the same meaning, namely a radio beacon designed for wireless connection to a network, most commonly using IEEE 802.11 standards. “GPS” is used as short hand to refer to any global navigational satellite system (GNSS) including the NAVSTAR global positioning system, Beidou, Glonass, Galileo, and other satellite navigation systems.

FIG. 1 is a schematic diagram illustrating the architecture of a communications system 100 in accordance with one embodiment of the disclosure. As shown in FIG. 1, the communications system 100 may include a mobile device 110, a plurality of Wi-Fi beacons 120, 122, 124, and 126, a server 130 (e.g., a crowdsourcing server) and a database 140 of Wi-Fi beacon locations.

The Wi-Fi beacons 120, 122, 124, and 126 can communicate with the mobile device 110 using various communication protocols. In some implementations, the Wi-Fi beacons can be an access point (AP) of a Wi-Fi network, which implements an Institute of Electrical and Electronics Engineers (IEEE) 802.11 based protocol (e.g., IEEE 802.11a). Each Wi-Fi beacon can have a communication range that can reach from the location of the Wi-Fi beacon to anywhere within a range from less than ten meters up to several hundred meters, depending on factors including configuration of the Wi-Fi beacon and its physical surroundings.

The mobile device 110 can be a location-aware mobile device, such as, a GPS-enabled mobile device that is coupled with a receiver that can receive Global Positioning System (GPS) signals and determine locations using these GPS signals. Measuring requests may originate from the mobile device 110 and may be sent to the server 130 which may in turn send a request to a Wi-Fi beacon within the communications range of the mobile device 110.

The mobile device 110 can generate raw observation data associated with visible Wi-Fi beacons according to signals received from the visible Wi-Fi beacons. Then, the mobile device 110 can periodically report the raw observation data to the server 130. TABLE 1 shows the raw observation data consisting of measurement reports. Each row of TABLE 1 is one measurement report, and each measurement report includes an identifying report number, a raw location estimate if available, and identifying information of each Wi-Fi beacon detected by the mobile device 110.

TABLE 1

| REPORT | | RAW LOCATION | Wi-Fi | | |
|---|---|---|---|---|---|
| NUMBER | GPS FLAG | ESTTIMATE | BEACON ID | | |
| 1 | ● | (x₁, y₁) | A | B | C |
| 2 | ● | (x₂, y₂) | B | C | |
| 3 | ● | (x₃, y₃) | A | C | D |
| 4 | | | A | D | |

In TABLE 1, the first column, “REPORT NUMBER”, lists information that identifies each measurement report. The second column, “GPS FLAG”, indicates whether the mobile device that detects the Wi-Fi beacons listed in the measurement report was able to estimate its position based on GPS signals received at the time of the measurement report (i.e. a “contemporaneous GPS position estimate”). In TABLE 1, a dot in the GPS FLAG column indicates that the raw location estimate is a GPS position estimate which is available and the “RAW LOCATION ESTTIMATE” column contains location information, e.g., GPS-based position information or an inferred location estimate. Columns labeled “Wi-Fi BEACON ID” list identification data of the Wi-Fi beacons detected by the mobile device 110. The first row of TABLE 1 indicates that the Wi-Fi beacons with ID A, B and C were detected by the mobile device 110 and that a simultaneous raw location estimate is available.

In another embodiment, TABLE 1 may further include additional columns not shown in TABLE 1 above. For example, TABLE 1 may include a column, “INFERENCE FLAG”, which indicates whether the raw location estimate is an inferred position. In addition, the raw observation data may further contain other observation data of the visible Wi-Fi beacons which is not shown in TABLE 1. For example, Service Set Identifiers (SSIDs), Basic Service Set Identifiers (BSSIDs) and signal strengths of the visible Wi-Fi beacons which were observed by the mobile device 110 at the raw location estimates.

The server 130 uses the raw observation data to compute inferred-location estimates for the Wi-Fi beacons 120, 122, 124, and 126 and builds/updates the database 140 of Wi-Fi beacon locations to improve the accuracy of the database 140 of Wi-Fi beacon locations.

The database 140 of Wi-Fi beacon locations may comprises two kinds of database structures. The first one is a non-relational database, which is an open source non-relational distributed database (e.g., HBase). The raw observation data transmitted by the mobile device 110 can be stored in the non-relational database. The other one is a relational database system (RDS), which is used to manage large amounts of data that does not require the functionality of the RDS.

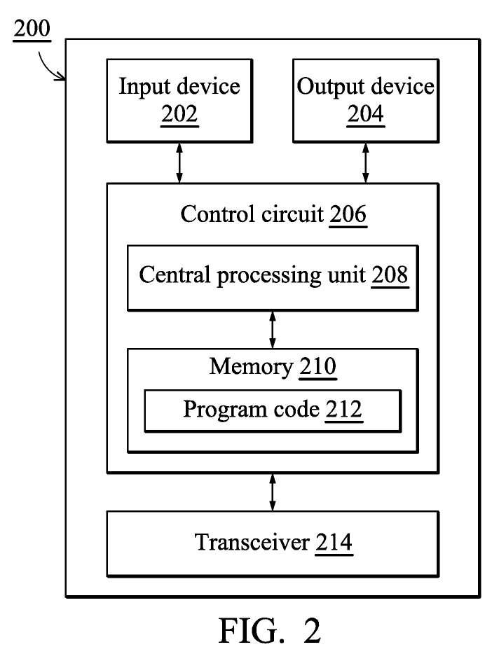

Next, turning to FIG. 2, FIG. 2 shows an alternative simplified functional block diagram of a communications device 200 according to one embodiment of the present disclosure. As shown in FIG. 2, the communications device 200 can be utilized for realizing the server 130. The communications device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the communications device 200. The communications device 200 can receive signals input by a user through the input device 202, such as a keyboard or keypad, and can output images and sound through the output device 304, such as a monitor or speakers. The transceiver 214 is used to receive and transmit wireless signals wirelessly, deliver received signals to the control circuit 206, and output signals generated by the control circuit 206.

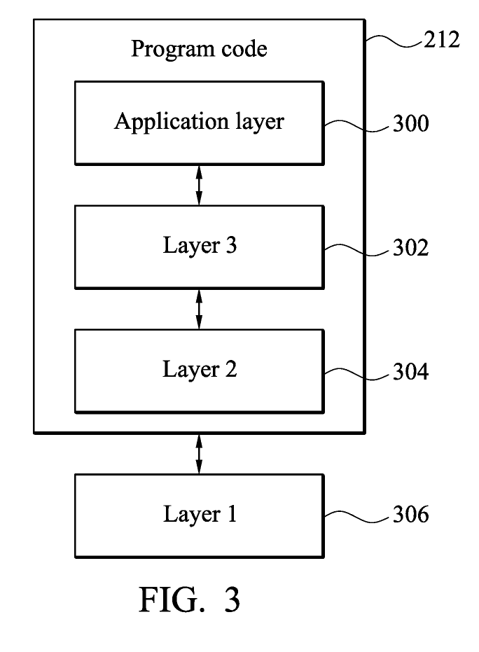

FIG. 3 is a simplified block diagram of the program code 212 shown in FIG. 2 in accordance with one embodiment of the disclosure. In this embodiment, the program code 212 includes an application layer 300, a Layer 3 portion 302, and a Layer 2 portion 304, and is coupled to a Layer 1 portion 306. The Layer 3 portion 302 generally performs radio resource control. The Layer 2 portion 304 generally performs link control. The Layer 1 portion 306 generally performs physical connections.

In the present disclosure, the database of Wi-Fi beacon locations can be built/updated by the server in four sub-procedures. The detailed description of the four sub-procedures will be described below.

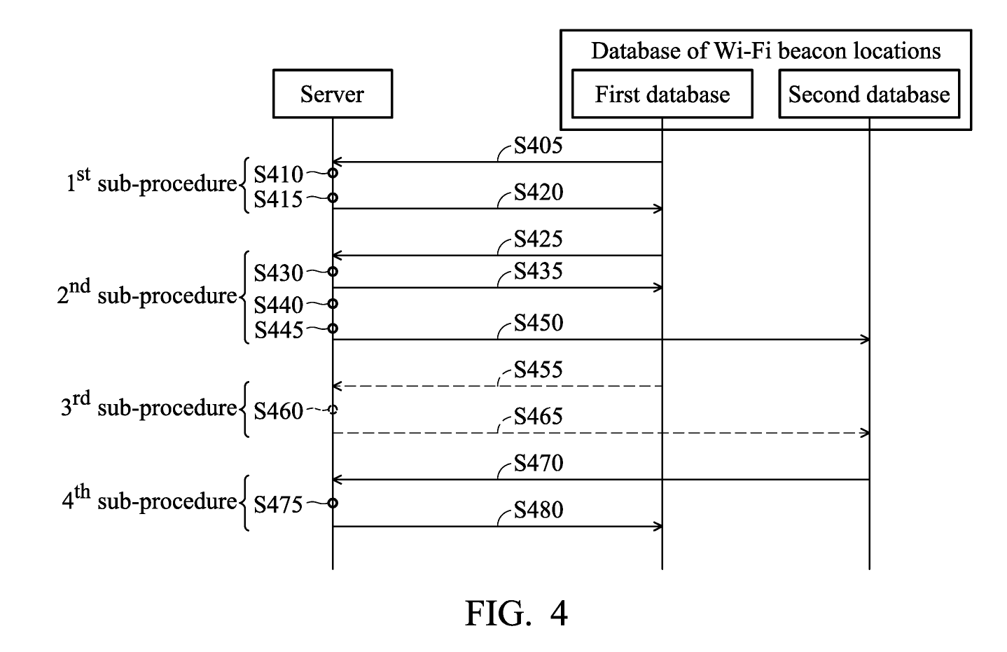

FIG. 4 illustrates a procedure for performing a method for constructing a database of Wi-Fi beacon locations between a first database, a second database and a server according to an embodiment of the present disclosure, wherein the first database is a non-relational database, and the second database is an RDS.

The procedure is separable into four sub-procedures. The first sub-procedure is associated with steps S405 to step S420 of FIG. 4. The purpose of the first sub-procedure is to generate observation data records for the Wi-Fi beacons and compute a rough location estimate for each Wi-Fi beacon. It should be noted that the raw observation data for the Wi-Fi beacons may be stored in the first database in advance before the procedure.

In step S405, the server obtains the raw observation data for the Wi-Fi beacons from the first database. In step S410, the server generates observation data records for the Wi-Fi beacons according to the raw observation data. Specifically, the server may perform a mapping process for the raw observation data. The server converts the raw observation data into observation data records by mapping the raw location estimates into the Wi-Fi beacons. For example, TABLE 2 shows the observation data records. Each row of TABLE 2 is one observation data record, and each observation data record includes identifying information of each Wi-Fi beacon and raw location estimate(s) corresponding to each Wi-Fi beacon.

TABLE 2

| Wi-Fi BEACON ID | RAW LOCATION ESTIMATE |
|---|---|
| A | (x₁, y₁), (x₃, y₃) |
| B | (x₁, y₁), (x₂, y₂) |
| C | (x₁, y₁), (x₂, y₂), (x₃, y₃) |
| D | (x₃, y₃) |

In TABLE 2, the left column, “Wi-Fi BEACON ID”, lists the identification data of the Wi-Fi beacons. The second column, “RAW LOCATION ESTTIMATE”, contains the location information, e.g., GPS-based position information or an inferred location estimate, which are mapped to the corresponding Wi-Fi beacons according to TABLE 1. The first row of TABLE 2 indicates that the raw location estimates, (x₁, y₁) and (x₃, y₃) are mapped to the Wi-Fi beacon with ID A. It should be noted that, in TABLE 1, only measurement reports having a location fix, e.g., GPS position information (GPS FLAG set) or inferred location estimates (INFERENCE FLAG set) are selected to be converted into the observation data records. Therefore, each raw location estimate in the observation data records has a location fix.

In the embodiment, even though some Wi-Fi beacons have the raw location estimates, they may still be mobile. Thus, the server may further examine whether the Wi-Fi beacons are mobile according to a mobile beacon identification rule. For example, a user who desires to share Wi-Fi access of his/her mobile device may set the mobile phone as a mobile Wi-Fi beacon. The name of a mobile device which is carried in SSID or BSSID may be set to a mnemonic name that is familiar to the user, e.g., Mary's phone. Therefore, it is assumed that the mobile beacon identification rule indicates whether the name of the mobile device contains people's names. The server can identify that the mobile phone is a mobile Wi-Fi beacon by examining the name of the mobile phone according to the mobile beacon identification rule, and then set a mobile flag of the mobile Wi-Fi beacon to “mobile” to indicate that the Wi-Fi beacon is a mobile beacon.

Then, in step S415, the server computes a rough location estimate for each Wi-Fi beacon according to the observation data records. It should be noted that this step is performed for each Wi-Fi beacon in the observation data records. In other words, this step will be performed for Wi-Fi beacon A, then the same set of sub-steps will be performed for Wi-Fi beacon B, then Wi-Fi beacon C, etc. Here Wi-Fi beacon A (ID A) is used as an example.

For each Wi-Fi beacon which does not have the mobile flag of “mobile”, the rough location estimate is computed according to signal strength measured in the raw location estimates. Using Wi-Fi beacon A as an example, inspection of TABLE 2 reveals two raw location estimates, (x₁, y₁) and (x₃, y₃). It is assumed that the Wi-Fi beacon A does not have the mobile flag of “mobile”, the server may compute the rough location estimate for Wi-Fi beacon A according to signal strength measured in the raw location estimates, (x₁, y₁) and (x₃, y₃).

Next, in step S420, the server may store the rough location estimates for the Wi-Fi beacons in the first database.

The second sub-procedure is associated with steps S425 to step S450 of FIG. 4. The purpose of the second sub-procedure is to find outliers of the Wi-Fi beacons and compute a final location estimate for each Wi-Fi beacon. The location estimates that do not cluster may be referred to as “outliers”. In order to illustrate this easily, in the following steps, Wi-Fi beacon A (ID A) is used as an example. However, those people skilled in the art should understand that those may also be performed for each Wi-Fi beacon in the observation data records.

In step S425, the server obtains the rough location estimate and the observation data record of Wi-Fi beacon A including the raw location estimates for Wi-Fi beacon A from the first database. Then, in step S430, the server finds the outliers of Wi-Fi beacon A from the rough location estimate and the observation data record of Wi-Fi beacon A. The underlying details of finding the outliers are now described. The server computes distances from the rough location estimate to each raw location estimate. Next, the server assigns a first raw location estimate whose distance from the rough location estimate for Wi-Fi beacon A exceeds a second threshold as an outlier, wherein the server can set an outlier flag to the first raw location estimate. In step S435, the server re-stores the first raw location estimates with the outlier flags in the first database. Then, in step S440, the server further examines whether the mobile flag of Wi-Fi beacon A is set to “mobile” indicating that Wi-Fi beacon A is a mobile beacon.

After examining that the mobile flag of Wi-Fi beacon A is not set to indicate that Wi-Fi beacon A is a mobile beacon, in step S445, the server computes a final location estimate for Wi-Fi beacon A according to signal strengths measured in the raw location estimates for Wi-Fi beacon A which does not include the outliers. In this step, the server may further compute a confidence score and/or a location uncertainty value for each Wi-Fi beacon according to the number of raw location estimates whose GPS FLAGs are set to dots (i.e. GPS position estimates) and the number of raw location estimates whose location estimates may be from the GPS position estimates or the inferred location estimates. The number of raw location estimates whose GPS FLAGs are set to dots and the number of raw location estimates whose location estimates may be from the GPS position estimates or the inferred location estimates are higher, and the confidence score is higher and/or the location uncertainty value is lower. It means that the more raw location estimates and GPS position estimates the server uses, the more accurate the final location estimate computed by the server.

In step S450, the server stores the final location estimate, the confidence score and/or the location uncertainty value, or the information whether the mobile flag of Wi-Fi beacon A is set to “mobile” in the second database. In another embodiment, the server may further determine whether the final location estimate conforms to rules utilized in the second database and perform at least one action in response to a determination result before storing the final location estimate for Wi-Fi beacon A in the second database. The rules may includes at least one of:
examining whether an original location estimate for Wi-Fi beacon A has been stored in the second database;
examining whether the mobile flag of Wi-Fi beacon A is set to indicate that Wi-Fi beacon A is a mobile beacon;
examining whether the original location estimate for Wi-Fi beacon A is measured by a user (i.e. the location estimate is known by survey);
examining whether a distance between the original location estimate and the final location estimate for Wi-Fi beacon A is greater than a third threshold.

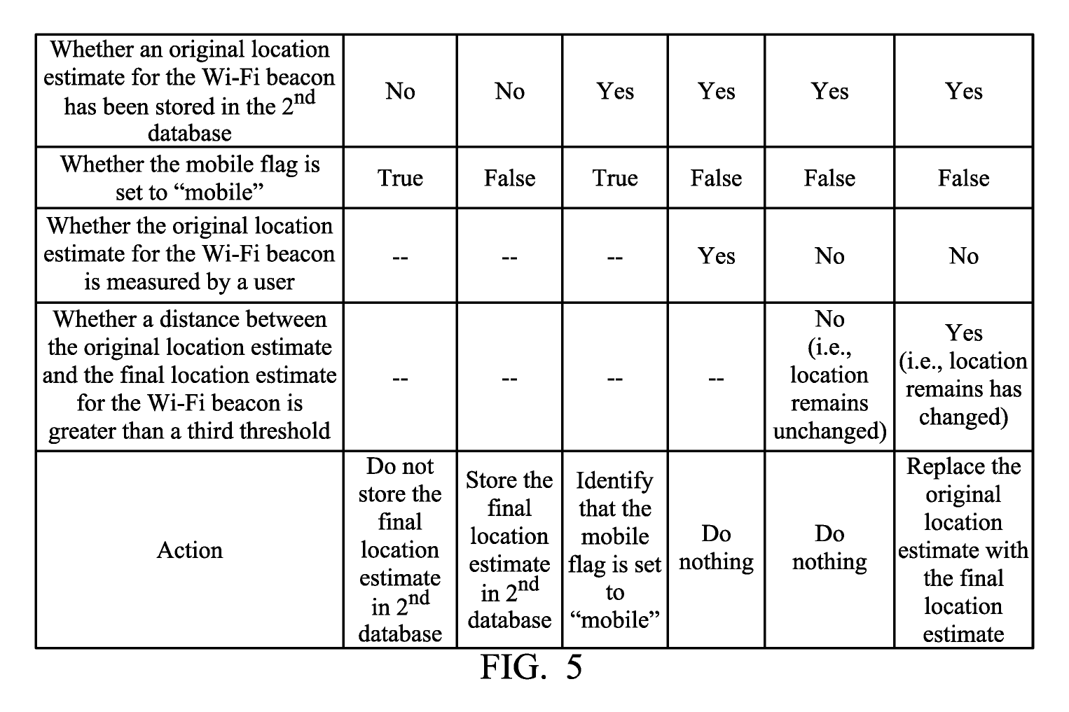

The at least one action in response to a determination result can be shown in FIG. 5. For example, when the server determines that the original location estimate for Wi-Fi beacon A has not been stored in the second database and determines that the mobile flag of Wi-Fi beacon A is set to “mobile”, the server does not store the final location estimate to the second database. Since Wi-Fi beacon A has been considered as a mobile Wi-Fi beacon, it is meaningless to store the final location estimate for Wi-Fi beacon A which is mobile in the second database.

The third sub-procedure is associated with steps S455 to step S465 of FIG. 4. The purpose of the third sub-procedure is to provide accuracy of the raw location estimates. In order to illustrate this easily, in the following steps, Wi-Fi beacon A (ID A) is used as an example. However, those people skilled in the art should understand that those may also be performed for each Wi-Fi beacon in the observation data records.

In step S455, the server may obtain the outliers and the raw location estimates for Wi-Fi beacon A. In step S460, the server determines whether a ratio of a number of outliers to a number of raw location estimates for Wi-Fi beacon A is greater than a first threshold, wherein the number of outliers can be computed according to the first raw location estimates with the outlier flags mentioned in step S435. In this step, the server may add a “distance mobile” tag to Wi-Fi beacon A to identify that Wi-Fi beacon A is a mobile beacon when determining that the ratio is greater than the first threshold. Next, in step S465, the server stores Wi-Fi beacon A with the “distance mobile” tag in the second database.

Alternatively, the server may not add a “distance mobile” tag to Wi-Fi beacon A when determining that the ratio is not greater than the first threshold. In another embodiment, the server may decide not to perform the third sub-procedure from step S455 to step S465 of FIG. 4, therefore step S455 to step S465 of FIG. 4 are depicted by dotted lines.

The fourth sub-procedure is associated with steps S470 to step S480 of FIG. 4. The purpose of the fourth sub-procedure is to compute inferred-location estimates which do not have a location fix in the raw observation data.

In step S470, the server obtains the final location estimates for the Wi-Fi beacons from the second database. Next, in step S475, the server computes inferred-location estimates for the Wi-Fi beacons which do not have a location fix according to the final location estimates. For example, referring back to TABLE 1, the server may compute an inferred-location estimate according to the final location estimates for Wi-Fi beacon A and Wi-Fi beacon D, and fill the inferred-location estimate in the blank space corresponding to the raw location estimate in the measurement report 4 of TABLE 1. In step S480, the server stores the inferred-location estimates in the first database.

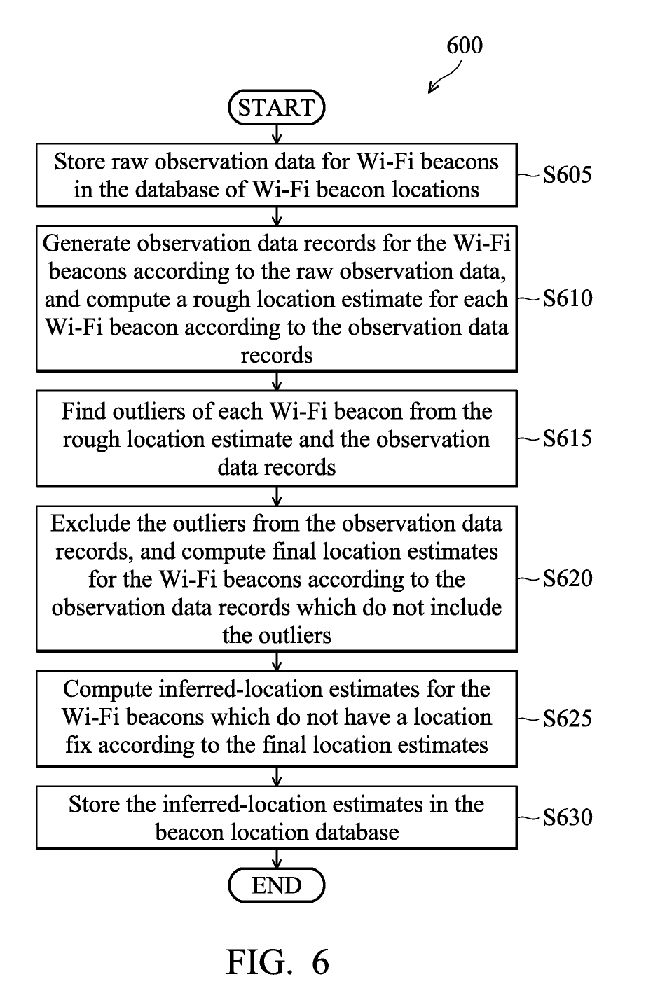

FIG. 6 is a flow diagram 600 illustrating a method for constructing a database of Wi-Fi beacon locations according to an embodiment of the present disclosure. The method is used in a server. In step S605, the server stores raw observation data for Wi-Fi beacons in the database of Wi-Fi beacon locations. Next, in step S610, the server generates observation data records for the Wi-Fi beacons according to the raw observation data, and computes a rough location estimate for each Wi-Fi beacon according to the observation data records. In step S615, the server finds outliers of each Wi-Fi beacon from the rough location estimate and the observation data records. In step S620, the server excludes the outliers from the observation data records, and computes final location estimates for the Wi-Fi beacons according to the observation data records which do not include the outliers. Then, in step S625, the server computes inferred-location estimates for the Wi-Fi beacons which do not have a location fix according to the final location estimates. In step S630, the server stores the inferred-location estimates in the beacon location database.

In addition, in the above exemplary system, although the method has been described on the basis of the procedure and the flow diagram using a series of the steps or blocks, the present disclose is not limited to the sequence of the steps, and some of the steps may be performed in a different order than that of the remaining steps or they may be performed simultaneously with the remaining steps. Furthermore, those skilled in the art will understand that the steps shown in the procedure and the flow diagram are not exclusive and they may include other steps or one or more steps of the procedure and the flow diagram may be deleted without affecting the scope of the present invention. For example, steps S455, S460 and S465 of FIG. 4 can be omitted.

In addition, the CPU 208 could execute the program code 212 to perform all of the above-described actions and steps or others described herein.

Although the inferred-location estimates are uncertain location information, the inferred-location estimates are still much more useful than no information. In addition, since the inferred-location estimates are stored back in the first database, the server may use the inferred-location estimates and the raw observation data to get more accurate location estimates for approximating real locations of the Wi-Fi beacons.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of exemplary embodiment, it should be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A method for constructing a database of Wi-Fi beacon locations, comprising:
(a) storing raw observation data for Wi-Fi beacons in the database of Wi-Fi beacon locations;
(b) generating observation data records for the Wi-Fi beacons according to the raw observation data, and computing a rough location estimate for each Wi-Fi beacon according to the observation data records;
(c) finding outliers of each Wi-Fi beacon from the rough location estimate and the observation data records;
(d) excluding the outliers from the observation data records, and computing final location estimates for the Wi-Fi beacons according to the observation data records which do not include the outliers;
(e) computing inferred-location estimates for the Wi-Fi beacons which do not have a location fix according to the final location estimates; and
(f) storing the inferred-location estimates in the beacon location database.

2. The method for constructing a database of Wi-Fi beacon locations as claimed in claim 1, wherein the observation data records include raw location estimates for the Wi-Fi beacons, and each raw location estimate has a location fix.

3. The method for constructing a database of Wi-Fi beacon locations as claimed in claim 2, wherein after computing the final location estimates for the Wi-Fi beacons, the method further comprises:
determining whether a ratio of a number of outliers to a number of raw location estimates for a first Wi-Fi beacon is greater than a first threshold;
adding a tag to the first Wi-Fi beacon when determining that the ratio of the first Wi-Fi beacon is greater than the first threshold; and
storing the first Wi-Fi beacon with the tag in a second database comprised in the database of Wi-Fi beacon locations.

4. The method for constructing a database of Wi-Fi beacon locations as claimed in claim 2, wherein the rough location estimate for each Wi-Fi beacon is computed according to signal strength measured in the raw location estimates.

5. The method for constructing a database of Wi-Fi beacon locations as claimed in claim 2, wherein finding the outliers of each Wi-Fi beacon from the rough location estimate and the observation data records comprises:
assigning a first raw location estimate for a first Wi-Fi beacon whose distance from the rough location estimate for the first Wi-Fi beacon exceeds a second threshold as the outlier.

6. The method for constructing a database of Wi-Fi beacon locations as claimed in claim 2, wherein computing the final location estimates further comprises:
examining whether a mobile flag of a first Wi-Fi beacon is set to indicate that the first Wi-Fi beacon is a mobile beacon;
computing the final location estimate for the first Wi-Fi beacon according to signal strengths measured in the raw location estimates for the first Wi-Fi beacon which does not include the outliers when examining the mobile flag of the first Wi-Fi beacon is not set to indicate that the first Wi-Fi beacon is a mobile beacon; and
storing the final location estimate for the first Wi-Fi beacon in a second database, wherein the second database is comprised in the database of Wi-Fi beacon locations.

7. The method for constructing a database of Wi-Fi beacon locations as claimed in claim 6, wherein storing the final location estimate for the first Wi-Fi beacon in the second database further comprises:
determining whether the final location estimate for the first Wi-Fi beacon conforms to rules utilized in the second database; and
performing at least one action in response to a determination result,
wherein the rules comprise:
examining whether an original location estimate for the first Wi-Fi beacon has been stored in the second database;
examining whether the mobile flag of the first Wi-Fi beacon is set to indicate that the first Wi-Fi beacon is a mobile beacon;
examining whether the original location estimate for the first Wi-Fi beacon is measured by a user; and
examining whether a distance between the original location estimate and the final location estimate is greater than a third threshold.

8. The method for constructing a database of Wi-Fi beacon locations as claimed in claim 1, wherein the inferred-location estimates are stored in a first database comprised in the database of Wi-Fi beacon locations.

9. The method for constructing a database of Wi-Fi beacon locations as claimed in claim 8, wherein the first database is a non-relational database.

10. The method for constructing a database of Wi-Fi beacon locations as claimed in claim 3, wherein the second database is a relational database system (RDS).

11. A system for constructing a database of Wi-Fi beacon locations, comprising:
a database of Wi-Fi beacon locations;
a server, coupled to the database of Wi-Fi beacon locations, comprising:
a control circuit;
a processor installed in the control circuit; and
a memory installed in the control circuit and operatively coupled to the processor;
wherein the processor is configured to execute a program code stored in the memory to perform operations comprising:
(a) storing raw observation data for Wi-Fi beacons in the database of Wi-Fi beacon locations;
(b) generating observation data records for the Wi-Fi beacons according to the raw observation data, and computing a rough location estimate for each Wi-Fi beacon according to the observation data records;
(c) finding outliers of each Wi-Fi beacon from the rough location estimate and the observation data records;
(d) excluding the outliers from the observation data records, and computing final location estimates for the Wi-Fi beacons according to the observation data records which do not include the outliers;
(e) computing inferred-location estimates for the Wi-Fi beacons which do not have a location fix according to the final location estimates; and
(f) storing the inferred-location estimates in the beacon location database.

12. The system for constructing a database of Wi-Fi beacon locations as claimed in claim 11, wherein the observation data records include raw location estimates for the Wi-Fi beacons, and each raw location estimate has a location fix.

13. The system for constructing a database of Wi-Fi beacon locations as claimed in claim 12, wherein after computing the final location estimates for the Wi-Fi beacons, the processor further executes the program code stored in the memory to perform operations comprising:
determining whether a ratio of a number of outliers to a number of raw location estimates for a first Wi-Fi beacon is greater than a first threshold;
adding a tag to the first Wi-Fi beacon when determining that the ratio of the first Wi-Fi beacon is greater than the first threshold; and
storing the first Wi-Fi beacon with the tag in a second database comprised in the database of Wi-Fi beacon locations.

14. The system for constructing a database of Wi-Fi beacon locations as claimed in claim 12, wherein the rough location estimate for each Wi-Fi beacon is computed according to signal strength measured in the raw location estimates.

15. The system for constructing a database of Wi-Fi beacon locations as claimed in claim 12, wherein finding the outliers of each Wi-Fi beacon from the rough location estimate and the observation data records comprises:
assigning a first raw location estimate for a first Wi-Fi beacon whose distance from the rough location estimate for the first Wi-Fi beacon exceeds a second threshold as the outlier.

16. The system for constructing a database of Wi-Fi beacon locations as claimed in claim 12, wherein computing the final location estimates further comprises:
examining whether a mobile flag of a first Wi-Fi beacon is set to indicate that the first Wi-Fi beacon is a mobile beacon;
computing the final location estimate for the first Wi-Fi beacon according to signal strength measured in the raw location estimates for the first Wi-Fi beacon which does not include the outliers when examining the mobile flag of the first Wi-Fi beacon is not set to indicate that the first Wi-Fi beacon is a mobile beacon; and
storing the final location estimate for the first Wi-Fi beacon in a second database, wherein the second database is comprised in the database of Wi-Fi beacon locations.

17. The system for constructing a database of Wi-Fi beacon locations as claimed in claim 16, wherein storing the final location estimate for the first Wi-Fi beacon in the second database further comprises:
determining whether the final location estimate for the first Wi-Fi beacon conforms to rules utilized in the second database; and
performing at least one action in response to a determination result,
wherein the rules comprise:
examining whether an original location estimate for the first Wi-Fi beacon has been stored in the second database;
examining whether the mobile flag of the first Wi-Fi beacon is set to indicate that the first Wi-Fi beacon is a mobile beacon;
examining whether the original location estimate for the first Wi-Fi beacon is measured by a user; and
examining whether a distance between the original location estimate and the final location estimate is greater than a third threshold.

18. The system for constructing a database of Wi-Fi beacon locations as claimed in claim 11, wherein the inferred-location estimates are stored in a first database comprised in the database of Wi-Fi beacon locations.

19. The system for constructing a database of Wi-Fi beacon locations as claimed in claim 18, wherein the first database is a non-relational database.

20. The system for constructing a database of Wi-Fi beacon locations as claimed in claim 13, wherein the second database is a relational database system (RDS).
